(19) United States
(12) Patent Application Publication
(10) Pub. No.: US 2026/0034890 A1
(43) Pub. Date: Feb. 5, 2026

(54) RELAY DIAGNOSIS APPARATUS FOR VEHICLE

(71) Applicant: SUBARU CORPORATION, Tokyo (JP)

(72) Inventor: Kazuya FUKE, Tokyo (JP)

(21) Appl. No.: 19/119,227

(22) PCT Filed: Sep. 21, 2023
(86) PCT No.: PCT/JP2023/034239

§ 371 Date: Apr. 8, 2025

(51) Int. Cl. B60L 3/00; G07C 5/08

(52) U.S. Cl. CPC B60L 3/0046; G07C 5/0808; B60L 2210/10

(57) ABSTRACT

A relay diagnosis apparatus for a vehicle includes a first detector, a second detector, a third detector, and a control system. The first detector detects a voltage of a converter. The second detector detects a voltage that is a potential difference between a first electric power line between a first relay and the converter, and a second electric power line between a second relay and an electric power storage unit. The third detector detects an inter-terminal voltage of the first relay. The control system performs matching a voltage of the electric power storage unit and the voltage of the converter to each other, diagnosing the first relay as having an OFF-fixation abnormality, outputting an ON signal to the second relay, diagnosing the second relay as having the OFF-fixation abnormality, diagnosing the second relay as having an ON-fixation abnormality, and diagnosing the first relay as having the ON-fixation abnormality.

### TECHNICAL FIELD

The disclosure relates to a relay diagnosis apparatus for a vehicle.

### BACKGROUND ART

Diagnosis is made of presence or absence of welding of a relay provided in a vehicle (refer to Patent Literatures 1 to 3). A vehicle has been proposed that includes no precharge circuit that is adapted to reduce welding of the relay (refer to Patent Literatures 1 and 2).

### CITATION LIST

### Patent Literature

Patent Literature 1: Japanese Unexamined Patent Application Publication No. 2020-099129

Patent Literature 2: Japanese Unexamined Patent Application Publication No. 2007-295699

Patent Literature 3: Japanese Unexamined Patent Application Publication No. 2011-055631

### SUMMARY OF INVENTION

### Problem to be Solved by the Invention

When diagnosis is made of presence or absence of malfunctions in relays, in a configuration as in Patent Literatures 1 and 2, a converter is to be turned on at least once and off at least once in diagnosis of one relay. That is, to diagnose respective malfunctions in the relays, the converter is to be turned on and off multiple times. Accordingly, there is room for improvement.

It is an object of the invention to reduce complication of diagnosis of presence or absence of malfunctions in relays.

### Means for Solving the Problem

A relay diagnosis apparatus for a vehicle according to one embodiment is configured to diagnose an operation of a first relay and an operation of a second relay of the vehicle in which a first electric power line provided with the first relay and a second electric power line provided with the second relay couple an electric power storage unit and a converter to each other, the second electric power line being different in polarity from the first electric power line. The relay diagnosis apparatus includes a first detector, a second detector, a third detector, and a control system. The first detector is configured to detect a voltage of the converter. The second detector is configured to detect a voltage that is a potential difference between the first electric power line between the first relay and the converter, and the second electric power line between the second relay and the electric power storage unit. The third detector is configured to detect an inter-terminal volage of the first relay. The control system includes a processor and a memory, and is configured to control the converter, the first relay, and the second relay. The control system is configured to perform matching the voltage of the converter to a voltage of the electric power storage unit, outputting an ON signal to the first relay in a state in which the converter is on, diagnosing the first relay as having an OFF-fixation abnormality when neither the voltage detected by the second detector nor the inter-terminal voltage detected by the third detector is detectable, outputting the ON signal to the second relay in a state in which the converter and the first relay are on, outputting an OFF signal to the converter, and diagnosing the second relay as having the OFF-fixation abnormality when the voltage at the first detector decreases, diagnosing the second relay as having an ON-fixation abnormality when the voltage at the first detector does not decrease after the OFF signal is outputted to the second relay, in a state in which the converter is off and the first relay is on, and diagnosing the first relay as having the ON-fixation abnormality when the inter-terminal voltage of the third detector is 0 (V) after the OFF signal is outputted to the first relay, in a state in which the converter is off and the second relay is off.

### Effects of the Invention

In the relay diagnosis apparatus for the vehicle according to one embodiment, the control system performs the respective steps to cause the converter to be turned on once and off once. This makes it possible to reduce complication of diagnosis of presence or absence of malfunctions in relays.

### BRIEF DESCRIPTION OF DRAWINGS

FIG. 1 is a diagram illustrating a hybrid vehicle including a relay diagnosis apparatus according to a first embodiment.

FIG. 2 is a block diagram illustrating a schematic configuration of the hybrid vehicle including the relay diagnosis apparatus according to the first embodiment.

FIG. 3 is a block diagram illustrating an example of a functional configuration of a control system.

FIG. 4 is a diagram illustrating an example of a basic structure of a control unit.

FIG. 5 is a graph illustrating times when a system main relay in the hybrid vehicle according to the first embodiment is switched on and off, and voltages detected at the respective times.

FIG. 6 is a flowchart illustrating a first half of an execution procedure in the relay diagnosis apparatus according to the first embodiment and a second embodiment.

FIG. 7 is a flowchart illustrating a second half of the execution procedure in the relay diagnosis apparatus according to the first embodiment and the second embodiment.

FIG. 8 is a flowchart illustrating an example of the execution procedure in the relay diagnosis apparatus according to the second embodiment.

FIG. 9 is a block diagram illustrating an internal configuration of a hybrid vehicle including a relay diagnosis apparatus according to a modification example.

FIG. 10 is a graph illustrating times when a system main relay in the hybrid vehicle according to the modification example is switched on and off, and voltages detected at the respective times.

### MODES FOR CARRYING OUT THE INVENTION

A first embodiment, a second embodiment, and a modification example are described in detail with reference to the drawings. Note that, in the following description, the same or substantially the same configurations or components are denoted by the same reference numerals, and repeated descriptions thereof are omitted.

### First Embodiment

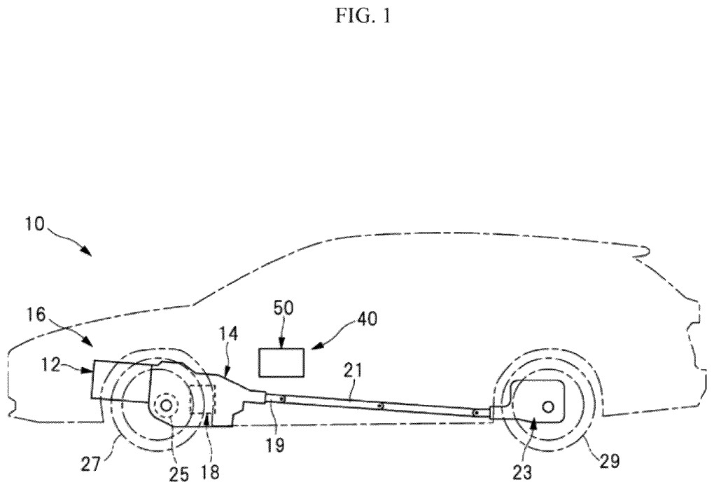

FIG. 1 is a diagram illustrating a hybrid vehicle 10 including a relay diagnosis apparatus 40 according to the first embodiment. The hybrid vehicle 10 is an example of a vehicle. The hybrid vehicle 10 is equipped with a power train 16 including an engine 12 and a transmission 14. The power train 16 includes an output shaft 19. The output shaft 19 is coupled to a rear wheel 29 via a propeller shaft 21 and a rear differential 23.

Furthermore, the transmission 14 incorporates a front differential 25. The front differential 25 is coupled to a front wheel 27. Note that a type of the hybrid vehicle 10 may be any one of a series type, a parallel type, or a series-parallel type. The power train 16 is an all-wheel-drive power train; however, the power train 16 is not limited thereto, and may include a front-wheel-drive power unit or a rear-wheel-drive power unit.

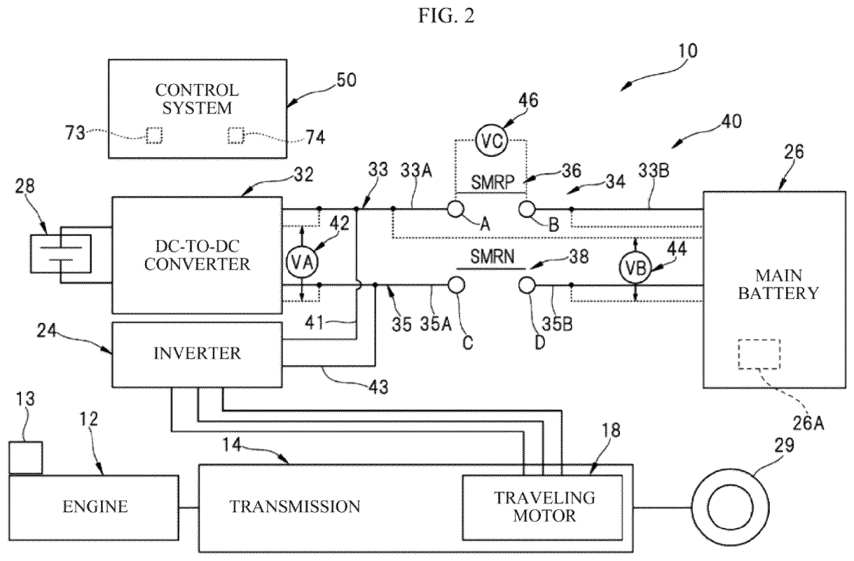

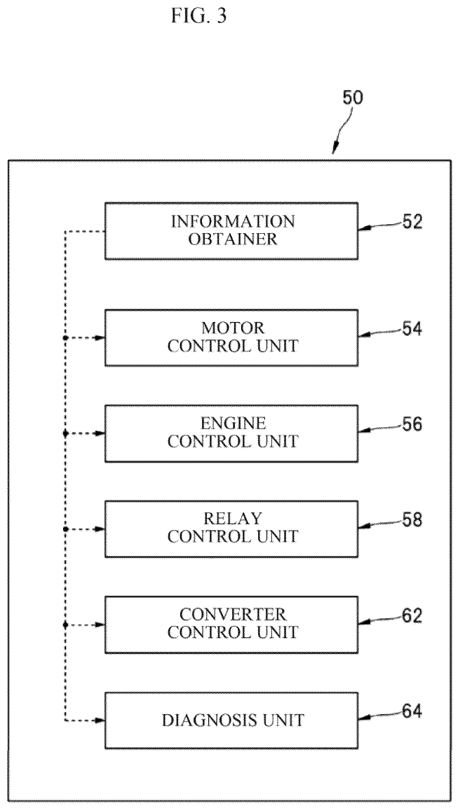

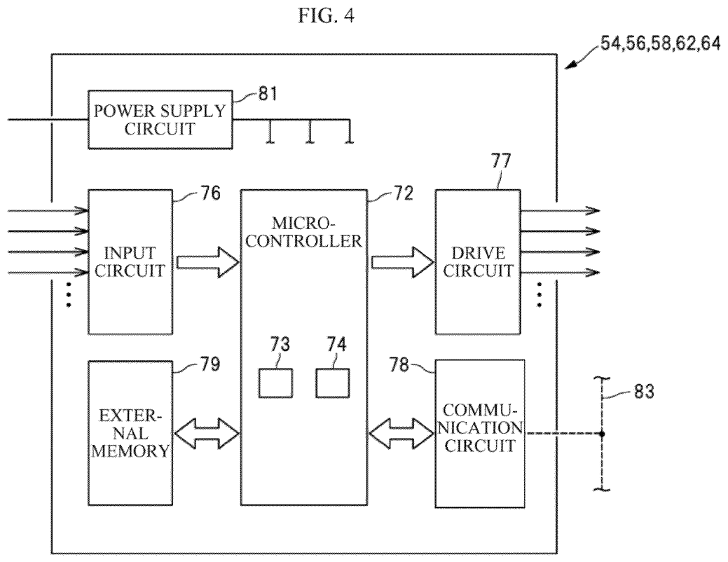

FIG. 2 is a block diagram illustrating a schematic configuration of the hybrid vehicle 10. FIG. 3 is a block diagram illustrating an example of a functional configuration of a control system 50. FIG. 4 is a diagram illustrating a basic structure of each of control units included in the control system 50.

As illustrated in FIG. 2, the hybrid vehicle 10 includes the engine 12, the transmission 14, a traveling motor 18, an inverter 24, a main battery 26, a sub-battery 28, a DC-to-DC converter 32, and a system main relay 34. DC stands for Direct Current. The hybrid vehicle 10 further includes a relay diagnosis apparatus 40.

The hybrid vehicle 10 is switchable between a HEV (Hybrid Electric Vehicle) traveling mode and an EV (Electric Vehicle) traveling mode. In the HEV traveling mode, the hybrid vehicle 10 travels with motive power from the engine 12 and motive power from the traveling motor 18. In the EV traveling mode, the hybrid vehicle 10 travels with the motive power from the traveling motor 18 in a state in which the engine 12 is stopped.

### <Engine>

The engine 12 is an internal combustion engine that generates motive power with a fuel such as gasoline. The engine 12 is configured to output motive power for driving of the front wheel 27 and the rear wheel 29 of the hybrid vehicle 10. A crankshaft that is an output shaft of the engine 12 is coupled to the transmission 14 via, for example, a torque converter. The transmission 14 changes the motive power outputted from the engine 12 and transmits the changed motive power to the front wheel 27 and the rear wheel 29.

The engine 12 includes an ISG (Integrated Starter Generator) 13. An output shaft of the ISG 13 is coupled to the crankshaft of the engine 12 via a gear. Motive power outputted from the ISG 13 is transmitted to the crankshaft of the engine 12. In one example, the ISG 13 is coupled to the sub-battery 28. The ISG 13 generates motive power with electric power supplied from the sub-battery 28. Furthermore, the ISG 13 is configured to generate electric power with motive power outputted from the engine 12. The sub-battery 28 is chargeable with electric power generated by the ISG 13.

### <Transmission, Etc.>

For example, the traveling motor 18 is provided inside the transmission 14. The traveling motor 18 is an electric motor. The traveling motor 18 is coupled to the main battery 26 via the inverter 24. The traveling motor 18 is configured to perform a power running operation and a regenerative operation. The traveling motor 18 converts kinetic energy into electrical energy in the regenerative operation, and charges the main battery 26 via the inverter 24. Furthermore, the traveling motor 18 generates motive power with electric power supplied from the main battery 26 via the inverter 24.

### <Main Battery>

The main battery 26 is an example of an electric power storage unit that stores electric power to be supplied to the traveling motor 18. Specifically, the main battery 26 is a battery having a higher voltage (for example, 200 (V)) than a voltage of the sub-battery 28. A sensor 26A detects the voltage of the main battery 26. In one example, a secondary battery such as a lithium-ion battery or a nickel metal hydride battery is used as the main battery 26.

The main battery 26 is coupled to each of devices in the hybrid vehicle 10 via the DC-to-DC converter 32. Accordingly, in the hybrid vehicle 10, the DC-to-DC converter 32 is configured to step down electric power stored in the main battery 26 and supply the stepped-down electric power to each of the devices. The system main relay 34 to be described later is provided between the main battery 26 and the DC-to-DC converter 32.

### <Sub-Battery>

The sub-battery 28 is coupled to the main battery 26 via the DC-to-DC converter 32, a first electric power line 33, and a second electric power line 35. The sub-battery 28 is a battery having a lower voltage (for example, 12 V) than the voltage of the main battery 26. The sub-battery 28 is charged with electric power generated by the ISG 13. Electric power of the sub-battery 28 is supplied to the DC-to-DC converter 32. In one example, a secondary battery such as a lead-acid battery or a lithium-ion battery is used as the sub-battery 28.

### <DC-to-DC Converter>

The DC-to-DC converter 32 is an example of a converter coupled to the main battery 26 via the first electric power line 33, the second electric power line 35, and the system main relay 34. The DC-to-DC converter 32 changes the voltage of the sub-battery 28. Specifically, the DC-to-DC converter 32 steps up the voltage of the sub-battery 28. The DC-to-DC converter 32 is configured to output a voltage equal to the voltage of the main battery 26.

### <<First Electric Power Line>>

The first electric power line 33 includes a wiring 33A and a wiring 33B. The wiring 33A couples the DC-to-DC converter 32 and a terminal A to be described later of the system main relay 34 to each other. The wiring 33B couples a terminal B to be described later of the system main relay 34 and the main battery 26 to each other. The first electric power line 33 corresponds to a positive electrode-side wiring. The wiring 33A is coupled to one end of a wiring 41. Another end of the wiring 41 is coupled to the inverter 24.

### <<Second Electric Power Line>>

The second electric power line 35 includes a wiring 35A and a wiring 35B. The second electric power line 35 corresponds to a negative electrode-side wiring. That is, the second electric power line 35 is different in polarity from the first electric power line 33. The wiring 35A couples the DC-to-DC converter 32 and a terminal C to be described later of the system main relay 34 to each other. The wiring 35B couples a terminal D to be described later of the system main relay 34 and the main battery 26 to each other. The wiring 35A is coupled to one end of a wiring 43. Another end of the wiring 43 is coupled to the inverter 24. In this manner, in the hybrid vehicle 10, the first electric power line 33 and the second electric power line 35 couple the main battery 26 and the DC-to-DC converter 32 to each other.

### <System Main Relay>

The system main relay 34 is configured to electrically decouple and couple the main battery 26 and the DC-to-DC converter 32 to each other on each of a positive electrode side and a negative electrode side. The system main relay 34 enters an open state (a decoupled state) when the hybrid vehicle 10 is stopped. The system main relay 34 enters a closed state (a coupled state) when the hybrid vehicle 10 is started up and while the hybrid vehicle 10 is traveling. In the following description, an operation of causing the system main relay 34 to enter the closed state is referred to as an ON operation, and an operation of causing the system main relay 34 to enter the open state is referred to as an OFF operation. Specifically, the system main relay 34 includes a positive electrode-side relay 36 and a negative electrode-side relay 38. Note that “SMRP” illustrated in the drawings is an abbreviation for the positive electrode-side relay 36, and “SMRN” illustrated in the drawings is an abbreviation for the negative electrode-side relay 38.

### <<Positive Electrode-Side Relay>>

The positive electrode-side relay 36 is an example of a first relay having the terminal A and the terminal B. The positive electrode-side relay 36 is provided in the first electric power line 33 between the main battery 26 and the DC-to-DC converter 32. The ON operation and the OFF operation of the positive electrode-side relay 36 are controlled by the control system 50 to be described later.

### <<Negative Electrode-Side Relay>>

The negative electrode-side relay 38 is an example of a second relay having the terminal C and the terminal D. The negative electrode-side relay 38 is provided in the second electric power line 35 between the main battery 26 and the DC-to-DC converter 32. The ON operation and the OFF operation of the negative electrode-side relay 38 are controlled by the control system 50 to be described later.

### <Relay Diagnosis Apparatus>

The relay diagnosis apparatus 40 is an example of a relay diagnosis apparatus for a vehicle. The relay diagnosis apparatus 40 diagnoses an operation of the positive electrode-side relay 36 and an operation of the negative electrode-side relay 38 within a time period TP of one trip to be described later. Specifically, the relay diagnosis apparatus 40 diagnoses presence or absence of respective malfunctions in the positive electrode-side relay 36 and the negative electrode-side relay 38. In the present embodiment, the “malfunction” refers to “ON-fixation and OFF-fixation abnormalities”.

The “ON-fixation abnormality” indicates that even though the control system 50 to be described later outputs an OFF signal to the positive electrode-side relay 36 or the negative electrode-side relay 38, the positive electrode-side relay 36 or the negative electrode-side relay 38 does not enter an OFF state. Examples of the ON-fixation abnormality include a case where the positive electrode-side relay 36 or the negative electrode-side relay 38 is welded to a terminal.

The “OFF-fixation abnormality” indicates that even though the control system 50 outputs an ON signal to the positive electrode-side relay 36 or the negative electrode-side relay 38, the positive electrode-side relay 36 or the negative electrode-side relay 38 does not enter an ON state. Examples of the OFF-fixation abnormality include a case where a failure such as a contact failure occurs in a circuit that operates the positive electrode-side relay 36 or the negative electrode-side relay 38.

The relay diagnosis apparatus 40 includes a first voltage sensor 42, a second voltage sensor 44, a third voltage sensor 46, and the control system 50. Note that the control system 50 also serves as a control system for the entire hybrid vehicle 10.

### <<First Voltage Sensor>>

The first voltage sensor 42 is an example of a first detector. The first voltage sensor 42 detects a voltage of the DC-to-DC converter 32 on a side of the main battery 26. Specifically, the first voltage sensor 42 is coupled to the wiring 33A and the wiring 35A near an input/output terminal of the DC-to-DC converter 32. Hereinafter, the voltage detected by the first voltage sensor 42 is referred to as a voltage VA.

### <<Second Voltage Sensor>>

The second voltage sensor 44 is an example of a second detector. The second voltage sensor 44 is coupled to the wiring 33A between the positive electrode-side relay 36 and the DC-to-DC converter 32, and is coupled to the wiring 35B between the negative electrode-side relay 38 and the main battery 26. That is, the second voltage sensor 44 detects a voltage that is a potential difference between the first electric power line 33 between the positive electrode-side relay 36 and the DC-to-DC converter 32, and the second electric power line 35 between the negative electrode-side relay 38 and the main battery 26. Hereinafter, the voltage detected by the second voltage sensor 44 is referred to as a voltage VB.

### <<Third Voltage Sensor>>

The third voltage sensor 46 is an example of a third detector. The third voltage sensor 46 detects an inter-terminal voltage of the positive electrode-side relay 36. That is, the third voltage sensor 46 detects an inter-terminal voltage between the terminal A and the terminal B. Hereinafter, the inter-terminal voltage detected by the third voltage sensor 46 is referred to as a voltage VC.

### <<Control System>>

The control system 50 includes a processor 73 and a main memory 74. The main memory 74 is an example of a memory. The control system 50 controls an operation of each of the DC-to-DC converter 32, the positive electrode-side relay 36, and the negative electrode-side relay 38. The control system 50 is started up based on an operation of a switch by a driver. When the driver pushes the switch while depressing a brake pedal of the hybrid vehicle 10, the control system 50 controls the hybrid vehicle 10 to be brought into a ready-to-travel state (Ready-ON). a ready-to-travel state (Ready-ON).

Meanwhile, when the driver pushes the switch while depressing the brake pedal of the hybrid vehicle 10 in a state in which the hybrid vehicle 10 is controlled to be in the ready-to-travel state, the control system 50 controls the hybrid vehicle 10 to be brought into a stopped state (Ready-OFF).

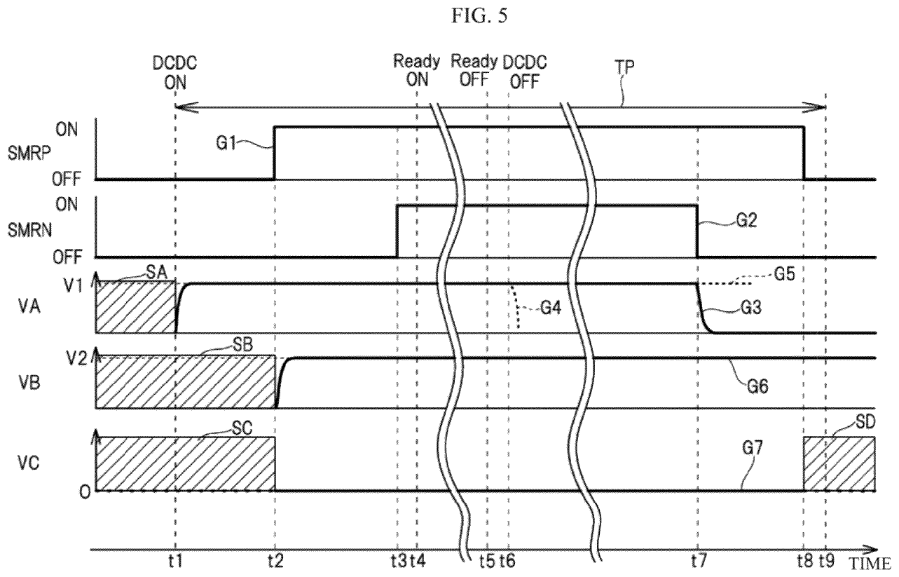

As illustrated in FIGS. 2 and 5, in the present embodiment, a time period from when the DC-to-DC converter 32 is turned on to when diagnosis by the relay diagnosis apparatus 40 ends is referred to as “one trip”. In the present embodiment, the time period TP from a time t1 to a time t9 corresponds to a time period taken by one trip. The DC-to-DC converter 32 performs the ON operation once and the OFF operation once within one trip. Note that DCDCON and DCDCOFF in the drawings respectively indicate on and off of the DC-to-DC converter 32.

A time when the diagnosis by the relay diagnosis apparatus 40 ends refers to a time when diagnosis of presence or absence of the respective malfunction (the ON-fixation abnormality and the OFF-fixation abnormality) in the positive electrode-side relay 36 and the negative electrode-side relay 38 ends. That is, the relay diagnosis apparatus 40 completes diagnosis of an operation of the system main relay 34 within one trip. Hereinafter, having at least one of the ON-fixation abnormality or the OFF-fixation abnormality may be collectively referred to as a “malfunction”.

A time when the hybrid vehicle 10 enters a Ready-ON state is set to t4, and a time when the hybrid vehicle 10 enters a Ready-OFF state is set to t5. The time t4 is a time after a time t3 when the ON signal is transmitted to the negative electrode-side relay 38. The time t5 is a time before a time t6 when the DC-to-DC converter 32 is turned off and after the time t4.

As illustrated in FIG. 3, the control system 50 includes an information obtainer 52, a motor control unit 54, an engine control unit 56, a relay control unit 58, a converter control unit 62, and a diagnosis unit 64.

### <<<Information Obtainer>>>

The information obtainer 52 obtains various kinds of information to be used for a process to be performed by the control system 50. Furthermore, the information obtainer 52 outputs the obtained information to the motor control unit 54, the engine control unit 56, the relay control unit 58, the converter control unit 62, and the diagnosis unit 64.

### <<<Motor Control Unit>>>

As illustrated in FIGS. 2 and 3, the motor control unit 54 controls an operation of the traveling motor 18. For example, the motor control unit 54 controls an operation of a switching device of the inverter 24 to thereby control supply of electric power between the traveling motor 18 and the main battery 26. This allows the motor control unit 54 to control generation of motive power and generation of electric power by the traveling motor 18.

### <<<Engine Control Unit>>>

The engine control unit 56 controls an operation of the engine 12. For example, the engine control unit 56 controls an operation of each of components included in the engine 12 to thereby control, for example, a throttle angle, an ignition timing, and a fuel injection quantity. This allows the engine control unit 56 to control output of the engine 12. The engine control unit 56 also controls an operation of the ISG 13. Specifically, the engine control unit 56 is configured to control a restart of the engine 12 by the ISG 13 by controlling supply of electric power from the sub-battery 28 to the ISG 13.

### <<<Relay Control Unit>>>

The relay control unit 58 controls an ON operation (a closing operation) and an OFF operation (an opening operation) of the system main relay 34. The ON operation of the system main relay 34 refers to an operation of switching the positive electrode-side relay 36 and the negative electrode-side relay 38 from off to on. The OFF operation of the system main relay 34 refers to an operation of switching the positive electrode-side relay 36 and the negative electrode-side relay 38 from on to off.

When the ON operation of the system main relay 34 is performed, the relay control unit 58 transmits the ON signal to the system main relay 34. When the OFF operation of the system main relay 34 is performed, the relay control unit 58 transmits the OFF signal to the system main relay 34.

### <<<Converter Control Unit>>>

The converter control unit 62 controls the operation of the DC-to-DC converter 32. Specifically, the converter control unit 62 controls an operation of a switching device of the DC-to-DC converter 32 to thereby control supply of electric power between the main battery 26 and the sub-battery 28.

### <<<Diagnosis Unit>>>

The diagnosis unit 64 diagnoses presence or absence of the malfunction in the system main relay 34. Specifically, the diagnosis unit 64 diagnoses presence or absence of the malfunction in the positive electrode-side relay 36 and presence or absence of the malfunction in the negative electrode-side relay 38. In one example, the driver is notified about a result of diagnosis by the diagnosis unit 64 by lighting of a lamp provided on an instrument panel of the hybrid vehicle 10.

As illustrated in FIG. 4, the motor control unit 54, the engine control unit 56, the relay control unit 58, the converter control unit 62, and the diagnosis unit 64 each include a microcontroller 72 including, for example, the processor 73 and the main memory 74. The main memory 74 holds a predetermined program.

The processor 73 and the main memory 74 are communicably coupled to each other. A program is executed by causing the processor 73 to read the predetermined program from the main memory 74, and develop and execute the predetermined program. Note that the microcontroller 72 may incorporate processors 73. The microcontroller 72 may incorporate main memories 74.

The motor control unit 54, the engine control unit 56, the relay control unit 58, and the converter control unit 62 each include an input circuit 76, a drive circuit 77, a communication circuit 78, an external memory 79, and a power supply circuit 81. The diagnosis unit 64 includes the input circuit 76, the communication circuit 78, the external memory 79, and the power supply circuit 81. The input circuit 76 converts signals received from various sensors into signals receivable by the microcontroller 72. The drive circuit 77 generates drive signals for various devices including the engine 12 described above, based on signals outputted from the microcontroller 72.

The communication circuit 78 converts the signals outputted from the microcontroller 72 into communication signals for other control units. The communication circuit 78 and each of the other control units are communicably coupled to each other via an in-vehicle network 83 such as a CAN (Controller Area Network). The communication circuit 78 also converts communication signals received from the other control units into signals receivable by the microcontroller 72.

The power supply circuit 81 supplies a power supply voltage to, for example, the microcontroller 72, the input circuit 76, the drive circuit 77, the communication circuit 78, and the external memory 79. The external memory 79 includes, for example, a nonvolatile memory. The external memory 79 holds programs and various pieces of data, for example.

In the hybrid vehicle 10 illustrated in FIG. 2, the control system 50 is configured to perform steps for diagnosis of the system main relay 34. Specifically, the control system 50 outputs the ON signal to the DC-to-DC converter 32 in a state in which the positive electrode-side relay 36 and the negative electrode-side relay 38 are off (in the open state). Thereafter, the control system 50 is configured to perform a step of matching the voltage VA of the DC-to-DC converter 32 to the voltage of the main battery 26.

The control system 50 outputs the ON signal to the positive electrode-side relay 36 in a state in which the DC-to-DC converter 32 is on. Thereafter, the control system 50 is configured to perform a step of diagnosing the positive electrode-side relay 36 as having the OFF-fixation abnormality when neither the volage VB of the second voltage sensor 44 nor the voltage VC of the third voltage sensor 46 is detectable. Note that “when no voltage is detectable” refers to when a resistance value is infinite and when a tester indicates over-range.

The control system 50 outputs the ON signal to the negative electrode-side relay 38 in a state in which the DC-to-DC converter 32 and the positive electrode-side relay 36 are on, and thereafter outputs the OFF signal to the DC-to-DC converter 32. Thereafter, the control system 50 is configured to perform a step of diagnosing the negative electrode-side relay 38 as having the OFF-fixation abnormality when the voltage VA at the first voltage sensor 42 decreases.

The control system 50 maintains the DC-to-DC converter 32 in the OFF state, and maintains the positive electrode-side relay 36 in the ON state. Thereafter, the control system 50 is configured to perform a step of diagnosing the negative electrode-side relay 38 as having the ON-fixation abnormality when the voltage VA of the first voltage sensor 42 does not decrease after outputting the OFF signal to the negative electrode-side relay 38.

The control system 50 maintains the DC-to-DC converter 32 in the OFF state, and maintains the negative electrode-side relay 38 in the OFF state. Thereafter, the control system 50 is configured to perform a step of diagnosing the positive electrode-side relay 36 as having the ON-fixation abnormality when the volage VC is 0 (V) after outputting the OFF signal to the positive electrode-side relay 36.

### Workings of First Embodiment

### <Relay Diagnosis Control: Flowchart>

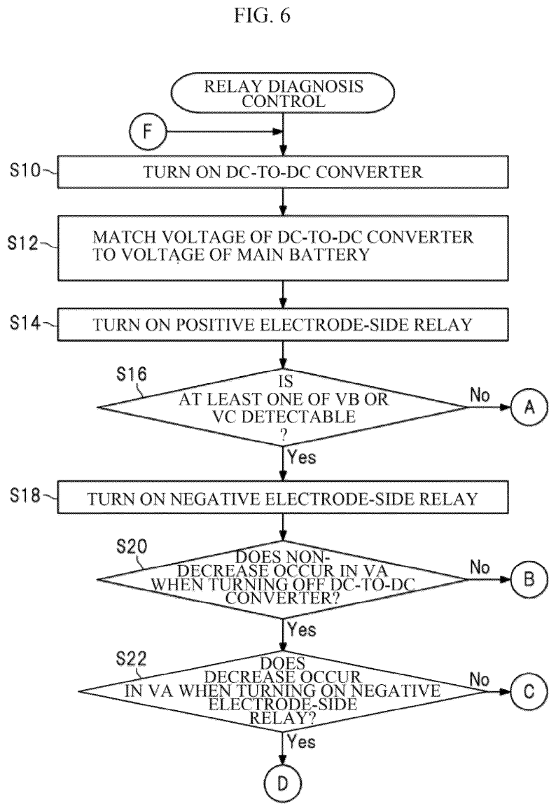

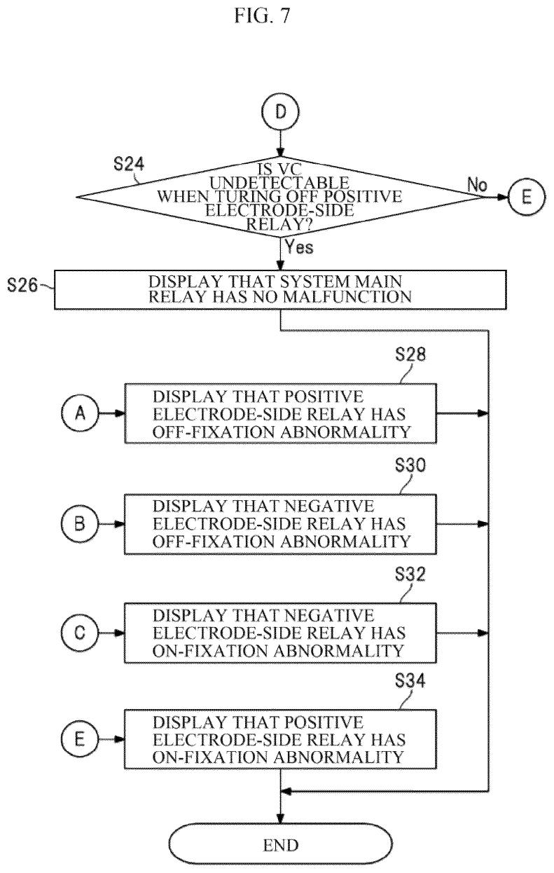

The following description is given of a procedure for executing relay (the system main relay 34) diagnosis control. Each of FIGS. 6 and 7 is a flowchart illustrating an example of the procedure for executing the relay diagnosis control. The flowcharts illustrated in FIGS. 6 and 7 are coupled to each other using connectors with reference signs A to E. A connector with a reference sign F is used in the second embodiment to be described later. Each of steps of relay control illustrated in FIGS. 6 and 7 is performed by the processor 73 included in the control system 50. Note that FIGS. 1 to 5 are referenced for respective configurations and respective voltages of the hybrid vehicle 10, and reference to individual drawing numbers is omitted.

As illustrated in FIG. 6, the control system 50 causes the program to proceed to step S10, and outputs the ON signal to the DC-to-DC converter 32 in a state in which the positive electrode-side relay 36 and the negative electrode-side relay 38 are off. Thereafter, the program is caused to proceed to step S12.

In step S12, the control system 50 adjusts the voltage VA of the DC-to-DC converter 32, based on the voltage of the main battery 26 detected by the sensor 26A to match the voltage VA of the DC-to-DC converter 32 to the voltage of the main battery 26. Thereafter, the program is caused to proceed to step S14.

In step S14, the control system 50 outputs the ON signal to the positive electrode-side relay 36 in a state in which the DC-to-DC converter 32 is on. Thereafter, the program is caused to proceed to step S16.

In step S16, the control system 50 determines whether neither the voltage VB nor the voltage VC is detectable. For example, when at least one of the voltage VB or the voltage VC is detectable such as when VB=V2 and VC=0 (V) (S16: Yes), the program is caused to proceed to step S18. When neither the voltage VB nor the voltage VC is detectable (S16: No), the program is caused to proceed to step S28.

In step S18, the control system 50 outputs the ON signal to the negative electrode-side relay 38 in a state in which each of the DC-to-DC converter 32 and the positive electrode-side relay 36 is on. Thereafter, the program is caused to proceed to step S20.

In step S20, the control system 50 outputs the OFF signal to the DC-to-DC converter 32, and determines whether a non-decrease from a voltage V1 occurs in the voltage VA. When the non-decrease from the voltage V1 occurs in the voltage VA (S20: Yes), the program is caused to proceed to step S22. When the non-decrease from the voltage V1 does not occur in the voltage VA (S20: No), the program is caused to proceed to step S30.

In step S22, the control system 50 outputs the OFF signal to the negative electrode-side relay 38, and determines whether a decrease from the voltage V1 occurs in the voltage VA. When the decrease from the voltage V1 occurs in the voltage VA (S22: Yes), the program is caused to proceed to step S24. When the decrease from the voltage V1 does not occur in the voltage VA (S22: No), the program is caused to proceed to step S32.

As illustrated in FIG. 7, in step S24, the control system 50 outputs the OFF signal to the positive electrode-side relay 36, and determines whether the voltage VC is undetectable or the voltage VC is 0 (V). When the voltage VC is undetectable (S24: Yes), the program is caused to proceed to step S26. When the voltage VC is 0 (V) (S24: No), the program is caused to proceed to step S34.

In step S26, the control system 50 displays a result of diagnosis that the system main relay 34 (the positive electrode-side relay 36 and the negative electrode-side relay 38) has no malfunction. For example, the control system 50 may display the result of the diagnosis by lighting of a lamp that is provided on a part of an instrument panel and indicates that the relay is in good condition, or may display, on a touch panel, an indication that the operation is good. Thereafter, the program ends. A result of diagnosis of presence or absence of the malfunction in the system main relay 34 is recorded as diagnosis information on the external memory 79.

In step S28, the control system 50 displays a result of diagnosis that the positive electrode-side relay 36 is in an OFF-fixation abnormality state, and records the result of the diagnosis on the external memory 79. Thereafter, the program ends. A method of displaying the result of the diagnosis may be similar to the method in step S26.

In step S30, the control system 50 displays a result of diagnosis that the negative electrode-side relay 38 is in the OFF-fixation abnormality state, and records the result of the diagnosis on the external memory 79. Thereafter, the program ends. A method of displaying the result of the diagnosis may be similar to the method in step S26.

In step S32, the control system 50 displays a result of diagnosis that the negative electrode-side relay 38 is in an ON-fixation abnormality state, and records the result of the diagnosis on the external memory 79. Thereafter, the program ends. A method of displaying the result of the diagnosis may be similar to the method in step S26.

In step S34, the control system 50 displays a result of diagnosis that the positive electrode-side relay 36 is in the ON-fixation abnormality state, and records the result of the diagnosis on the external memory 79. Thereafter, the program ends. A method of displaying the result of the diagnosis may be similar to the method in step S26.

FIG. 5 illustrates the ON state and the OFF state of the system main relay 34 at respective times, the detected voltage VA, the detected voltage VB, and the detected voltage VC. Note that FIGS. 1, 2, 3, and 4 are referenced for the respective configurations of the hybrid vehicle 10, and reference to the individual drawing numbers is omitted.

Intervals between respective times from the time t1 to the time t9 in FIG. 5, that is, lengths of time periods are each an example, and are not limited to illustrated time periods. Note that a time lag occurs from transmission of a control signal to a control target by the control system 50 until start of an operation by the control target, but the time lag is omitted in FIG. 5.

A graph G1 illustrated in FIG. 5 indicates times when the ON signal and the OFF signal are transmitted to the positive electrode-side relay 36. That is, the graph G1 does not indicate that the positive electrode-side relay 36 is in the ON state or in the OFF state.

A graph G2 indicates times when the ON signal and the OFF signal are transmitted to the negative electrode-side relay 38. That is, the graph G2 does not indicate that the negative electrode-side relay 38 is in the ON state or in the OFF state.

A graph G3 indicates the voltage VA detected by the first voltage sensor 42. A graph G6 indicates the voltage VB detected by the second voltage sensor 44. A graph G7 indicates the voltage VC detected by the third voltage sensor 46. In FIG. 5, a graph G4 and a graph G5 indicated by dotted lines are graphs when exhibiting a behavior different from a behavior of the graph G3.

In FIG. 5, a region SA, a region SB, a region SC, and a region SD that are diagonally shaded each refer to a region where no voltage is detectable.

As illustrated in FIG. 5, until just before the time t1, each of the positive electrode-side relay 36 and the negative electrode-side relay 38 is in the OFF state. The DC-to-DC converter 32 is in the OFF state. Furthermore, each of the voltage VA, the voltage VB, and the voltage VC is undetectable. Here, it can be seen that, when the voltage VC is equal to 0 (V) until the time t2 (in a case indicated by a dotted line), the positive electrode-side relay 36 is in the ON-fixation abnormality state. In other words, it can be seen that the positive electrode-side relay 36 is unable to perform the OFF operation.

When the DC-to-DC converter 32 is turned on at the time t1, the voltage VA increases to the voltage V1. When the positive electrode-side relay 36 has no ON-fixation abnormality, the voltage VB and the voltage VC are undetectable.

Upon transmitting the ON signal to the positive electrode-side relay 36 at the time t2, if the operation of the positive electrode-side relay 36 is normal, the positive electrode-side relay 36 enters the ON state. The voltage VA is the voltage V1. The voltage VB increases to the voltage V2. The voltage VC is 0 (V). Here, it can be seen that, when the voltage VB and the voltage VC are undetectable, the positive electrode-side relay 36 is in the OFF-fixation abnormality state. In other words, it can be seen that the positive electrode-side relay 36 is unable to perform the ON operation.

Upon transmitting the ON signal to the negative electrode-side relay 38 at the time t3, if the operation of the negative electrode-side relay 38 is normal, the negative electrode-side relay 38 enters the ON state. The voltage VA is the voltage V1. The voltage VB is the voltage V2. The voltage VC is 0 (V).

At the time t6, the DC-to-DC converter 32 is turned off. Here, it can be seen that, when the volage VA decreases as indicated in the graph G4, the negative electrode-side relay 38 is in the OFF-fixation abnormality state. In other words, it can be seen that the negative electrode-side relay 38 is unable to perform the ON operation.

Upon transmitting the OFF signal to the negative electrode-side relay 38 at the time t7, if the operation of the negative electrode-side relay 38 is normal, the negative electrode-side relay 38 enters the OFF state. At this time, the voltage VA decreases from the voltage V1. The voltage VB is the voltage V2. The voltage VC is 0 (V). Here, it can be seen that, when the voltage VA is maintained at the voltage V1 as indicated by the graph G5, the negative electrode-side relay 38 is in the ON-fixation abnormality state. In other words, it can be seen that the negative electrode-side relay 38 is unable to perform the OFF operation.

Upon transmitting the OFF signal to the positive electrode-side relay 36 at the time t8, if the operation of the positive electrode-side relay 36 is normal, the positive electrode-side relay 36 enters the OFF state. At this time, the voltage VA remains decreased from the voltage V1. The voltage VB is the voltage V2. The voltage VC is undetectable. Here, it can be seen that, when the voltage VC is 0 (V), the positive electrode-side relay 36 is in the ON-fixation abnormality state.

### <Conclusion of First Embodiment>

As described above, in the relay diagnosis apparatus 40, the control system 50 outputs the ON signal to the positive electrode-side relay 36. Thereafter, when neither the voltage VB nor the voltage VC is detectable, the relay diagnosis apparatus 40 diagnoses the positive electrode-side relay 36 as being in the OFF-fixation abnormality state. When, after outputting the ON signal to the negative electrode-side relay 38, the operation of the DC-to-DC converter 32 is stopped and the voltage VA decreases, the control system 50 diagnoses the negative electrode-side relay 38 as being in the OFF-fixation abnormality state.

When the voltage VA does not decrease after outputting the OFF signal to the negative electrode-side relay 38, the control system 50 diagnoses the negative electrode-side relay 38 as being in the ON-fixation abnormality state. After the OFF signal is outputted to the positive electrode-side relay 36 and when the voltage VC is 0 (V), the control system 50 diagnoses the positive electrode-side relay 36 as being in the ON-fixation abnormality state.

Thus, the relay diagnosis apparatus 40 performs the respective steps to cause the DC-to-DC converter 32 to be turned on once and off once in one diagnosis. In other words, the relay diagnosis apparatus 40 diagnoses presence or absence of the malfunction in the positive electrode-side relay 36 and presence or absence of the malfunction in the negative electrode-side relay 38 within one trip. As described above, in the relay diagnosis apparatus 40, it is possible to reduce complication of the diagnosis of presence or absence of the malfunctions in the positive electrode-side relay 36 and the negative electrode-side relay 38, as compared with a configuration in which the DC-to-DC converter 32 is turned on and off multiple times.

### Second Embodiment

A description is given below of the relay diagnosis apparatus 40 according to the second embodiment. Note that components that are the same as or similar to those of the first embodiment are denoted by the same reference numerals to avoid any redundant description. Regarding the configurations and the voltages illustrated in FIGS. 1 to 5, reference to individual drawing numbers is omitted.

As illustrated in the flowcharts in FIGS. 6, 7, and 8, the relay diagnosis apparatus 40 according to the second embodiment differs in that step S2 and step S4 are added before step S10. Step S10 and subsequent steps are similar to those of the first embodiment, and a description thereof is therefore omitted.

In the relay diagnosis apparatus 40 according to the second embodiment, it is possible to perform a step of detecting the voltage VC with the third voltage sensor 46, before the ON signal is outputted to the DC-to-DC converter 32 and when the OFF signal is outputted to the positive electrode-side relay 36. Furthermore, in the relay diagnosis apparatus 40, the program is configured to diagnose presence or absence of the malfunction (the ON-fixation abnormality) in the positive electrode-side relay 36 by causing the program to proceed to the next step in accordance with the value of the detected voltage VC before outputting the ON signal to the DC-to-DC converter 32. For example, when the voltage VC detected by the third voltage sensor 46 is 0 (V), the positive electrode-side relay 36 is diagnosed as being in the ON-fixation abnormality state.

### Workings of Second Embodiment

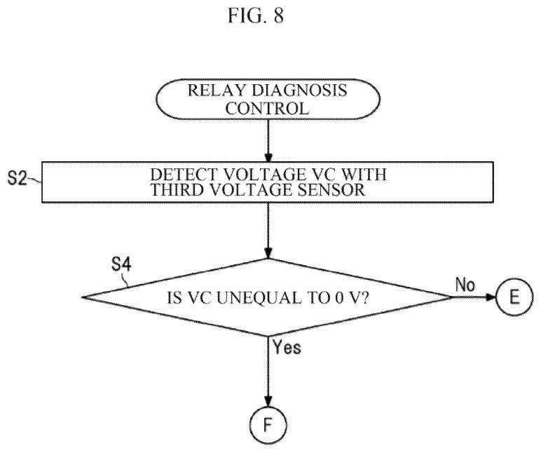

As illustrated in FIG. 8, in step S2, the control system 50 detects the voltage VC with the third voltage sensor 46, before the ON signal is outputted to the DC-to-DC converter 32 and when the OFF signal is outputted to the positive electrode-side relay 36. Thereafter, the program is caused to proceed to step S4.

In step S4, the control system 50 determines whether the voltage VC is unequal to 0 (V). When the voltage VC is unequal to 0 (V) (S4: Yes), the program is caused to proceed to step S10. When the voltage VC is equal to 0 (V) (S4: No), the program is caused to proceed to step S34.

In a stage before the DC-to-DC converter 32 enters the ON state, a state in which the positive electrode-side relay 36 is in the OFF state is regarded as a normal state. Here, when the voltage VC is 0 (V), the control system 50 diagnoses the positive electrode-side relay 36 as having the ON-fixation abnormality because the positive electrode-side relay 36 is in the ON state. As described above, in the second embodiment, it is possible to diagnose the positive electrode-side relay 36 as having the malfunction in a stage before one trip. Note that actions of step S10 and subsequent steps are similar to those of the first embodiment, and a description thereof is therefore omitted.

### Modification Examples

It is needless to say that embodiments of the invention are not limited to the first embodiment and the second embodiment and may be modified in various forms without departing from the scope of the invention.

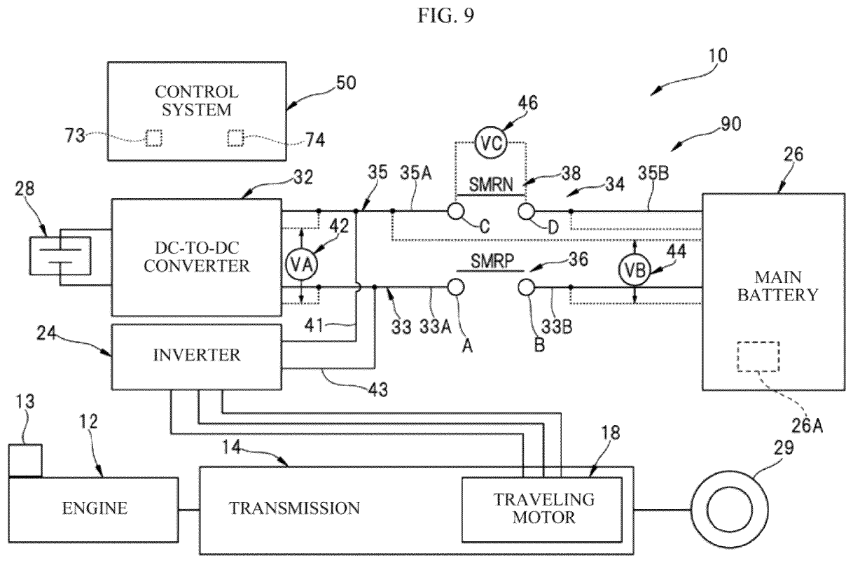

As illustrated in FIG. 9, the hybrid vehicle 10 including a relay diagnosis apparatus 90 may be used as a modification example. Note that configurations that are the same as or similar to those of the first embodiment and the second embodiment are denoted by the same reference numerals to avoid a description thereof.

The relay diagnosis apparatus 90 is an example of the relay diagnosis apparatus for the vehicle. The relay diagnosis apparatus 90 diagnoses presence or absence of the malfunctions (the ON-fixation abnormality and the OFF-fixation abnormality) in the positive electrode-side relay 36 and the negative electrode-side relay 38 within one trip. In one example, the relay diagnosis apparatus 90 includes the first voltage sensor 42, the second voltage sensor 44, the third voltage sensor 46, and the control system 50.

The relay diagnosis apparatus 90 differs from the relay diagnosis apparatus 40 according to the first embodiment in that a positive electrode-side configuration and a negative electrode-side configuration are replaced with each other. That is, the positive electrode-side relay 36 is an example of the second relay, and the negative electrode-side relay 38 is an example of the first relay. The first voltage sensor 42 is similar to that of the first embodiment. The third voltage sensor 46 detects the voltage VC that is an inter-terminal voltage of the negative electrode-side relay 38.

Specifically, the second voltage sensor 44 is coupled to the wiring 33B between the positive electrode-side relay 36 and the main battery 26, and is coupled to the wiring 35A between the negative electrode-side relay 38 and the DC-to-DC converter 32. The second voltage sensor 44 detects the voltage VB that is a potential difference between the first electric power line 33 between the positive electrode-side relay 36 and the main battery 26, and the second electric power line 35 between the negative electrode-side relay 38 and the DC-to-DC converter 32.

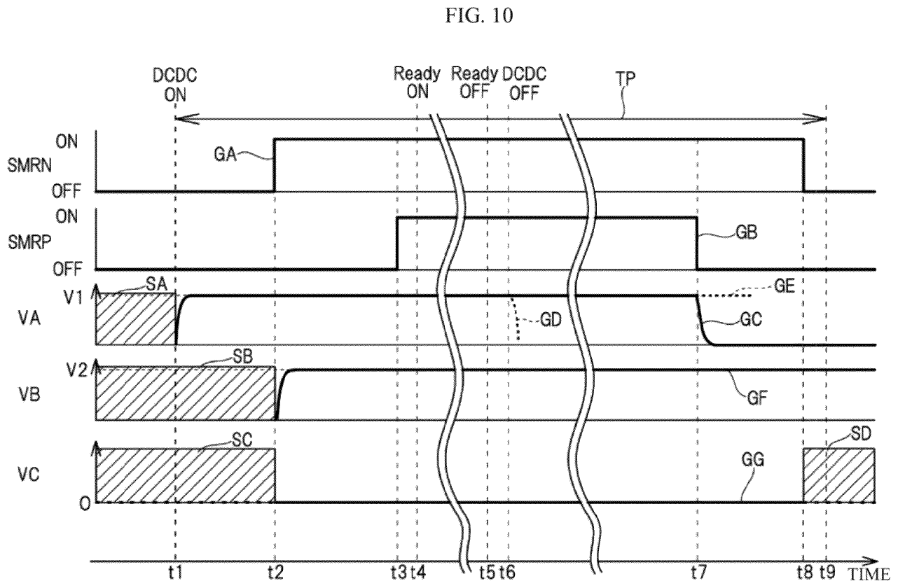

FIG. 10 illustrates graphs GA, GB, GC, GD, GE, GF, and GG regarding the relay diagnosis apparatus 90. The graph GA indicates timings at which the ON signal and the OFF signal are transmitted to the negative electrode-side relay 38. The graph GB indicates timings at which the ON signal and the OFF signal are transmitted to the positive electrode-side relay 36. The graph GC indicates the voltage VA. The graph GD indicates a state in which the voltage decreases when the DC-to-DC converter 32 is turned off. The graph GE indicates a state in which the voltage VA is maintained when the positive electrode-side relay 36 is turned off. The graph GF indicates the voltage VB. The graph GG indicates the voltage VC.

Note that the graphs GA, GB, GC, GD, GE, GF, and GG have tendencies similar to those of the graphs G1, G2, G3, G4, G5, G6, and G7 regarding the relay diagnosis apparatus 40, and a description thereof is therefore omitted. In this manner, the relay diagnosis apparatus 90 according to the modification example is also configured to diagnose presence or absence of the malfunctions (the ON-fixation abnormality and the OFF-fixation abnormality) in the positive electrode-side relay 36 and the negative electrode-side relay 38 within one trip.

The vehicle is not limited to the hybrid vehicle 10, and may be an electric vehicle (EV).

Upon diagnosing the voltage VC as being equal to 0 (V), even if the detected voltage is not equal to 0 (V), the voltage may be regarded as 0 (V) as long as the detected voltage is within a measurement error range with respect to 0 (V).

### Description of Reference Numerals

10 Hybrid vehicle (Example of vehicle)
26 Main battery (Example of electric power storage unit)
32 DC-to-DC converter (Example of converter)
33 First electric power line
35 Second electric power line
36 Positive electrode-side relay (Example of first relay)
38 Negative electrode-side relay (Example of second relay)
40 Relay diagnosis apparatus (Example of relay diagnosis apparatus for vehicle)
42 First voltage sensor (Example of first detector)
44 Second voltage sensor (Example of second detector)
46 Third voltage sensor (Example of third detector)
50 Control system
73 Processor
74 Memory
90 Relay diagnosis apparatus (Example of relay diagnosis apparatus for vehicle)
V1 Voltage
V2 Voltage
VA Voltage
VB Voltage
VC Voltage

1. A relay diagnosis apparatus for a vehicle, the relay diagnosis apparatus being configured to diagnose an operation of a first relay and an operation of a second relay of the vehicle in which a first electric power line provided with the first relay and a second electric power line provided with the second relay couple an electric power storage unit and a converter to each other, the second electric power line being different in polarity from the first electric power line, the relay diagnosis apparatus comprising:
a first detector configured to detect a voltage of the converter;
a second detector configured to detect a voltage that is a potential difference between the first electric power line between the first relay and the converter, and the second electric power line between the second relay and the electric power storage unit;
a third detector configured to detect an inter-terminal volage of the first relay; and
a control system comprising a processor and a memory, the control system being configured to control the converter, the first relay, and the second relay, wherein
the control system is configured to perform
matching the voltage of the converter to a voltage of the electric power storage unit,
outputting an ON signal to the first relay in a state in which the converter is on,
diagnosing the first relay as having an OFF-fixation abnormality when neither the voltage detected by the second detector nor the inter-terminal voltage detected by the third detector is detectable,
outputting the ON signal to the second relay in a state in which the converter and the first relay are on,
outputting an OFF signal to the converter, and diagnosing the second relay as having the OFF-fixation abnormality when the voltage at the first detector decreases,
diagnosing the second relay as having an ON-fixation abnormality when the voltage at the first detector does not decrease after the OFF signal is outputted to the second relay, in a state in which the converter is off and the first relay is on, and
diagnosing the first relay as having the ON-fixation abnormality when the inter-terminal voltage of the third detector is 0 (V) after the OFF signal is outputted to the first relay, in a state in which the converter is off and the second relay is off.

2. The relay diagnosis apparatus for the vehicle according to claim 1, wherein
the control system is configured to perform
detecting the inter-terminal voltage with the third detector, before the ON signal is outputted to the converter and when the OFF signal is outputted to the first relay, and
diagnosing the first relay as having the ON-fixation abnormality when the inter-terminal voltage detected by the third detector is 0 (V).
